(19) United States
(12) Patent Application Publication
(10) Pub. No.: US 2023/0103914 A1
(43) Pub. Date: Apr. 6, 2023

(54) STEERING SYSTEM

(71) Applicant: ZF FRIEDRICHSHAFEN AG, Friedrichshafen (DE)

(72) Inventors: Daniel E. WILLIAMS, Thorntown, IN (US); Shreyas Sharad CHAUDHARI, Lafayette, IN (US); Pranav Rajendra SALUNKE, West Lafayette, IN (US); Ananda Kamakshi Rajah PANDY, West Lafayette, IN (US)

(21) Appl. No.: 17/797,477

(22) PCT Filed: Feb. 8, 2021
(86) PCT No.: PCT/IB2021/051001

§ 371 Date: Aug. 4, 2022

Related U.S. Application Data
(60) Provisional application No. 62/971,379, filed on Feb. 7, 2020.

(51) Int. Cl. B62D 15/02; B62D 5/04

(52) U.S. Cl. CPC B62D 15/025; B62D 5/046; B62D 5/0409

(57) ABSTRACT

A vehicle steering system for use in turning steerable vehicle wheels includes a steering column and a steering gear operably connected with the steering column. The steering gear turns the steerable vehicle wheels upon rotation of the steering column. A first control assembly is connected to the steering column. The first control assembly has a first motor operably connected to the steering column for applying a torque to the steering column. A second control assembly is connected to the steering column. The second control assembly has a second motor operably connected to the steering column for applying a torque to the steering column. he second control assembly directly communicates with the first control assembly. A vehicle controller is configured to communicate with the first and second control assemblies to autonomously steer the vehicle.

### RELATED APPLICATION

This application claims priority to U.S. Provisional Application Ser. No. 62/971,379, filed Feb. 7, 2020, the subject matter of which is incorporated herein by reference in its entirety.

### TECHNICAL FIELD

The present invention relates to a steering system for turning steerable wheels of a vehicle, and, more specifically to a steering system for turning steerable wheels in response to rotation of a vehicle steering wheel and/or autonomously.

### BACKGROUND

Vehicle steering systems for commercial vehicles do not support autonomous steering of the vehicle without an operator/driver of the vehicle. The operator of the vehicle determines the effects of any failure related to the steering system and controls the vehicle steering in the event of the failure. Therefore, an operator is necessary for the safe operation of the vehicle.

### SUMMARY

The present invention provides a vehicle steering system for use in turning steerable vehicle wheels having a steering column and a steering gear operably connected with the steering column. The steering gear turns the steerable vehicle wheels upon rotation of the steering column. A first control assembly is connected to the steering column. The first control assembly has a first motor operably connected to the steering column for applying a torque to the steering column. A second control assembly is connected to the steering column. The second control assembly has a second motor operably connected to the steering column for applying a torque to the steering column. The second control assembly directly communicates with the first control assembly. A vehicle controller is configured to communicate with the first and second control assemblies to autonomously steer the vehicle,

### BRIEF DESCRIPTION OF THE DRAWINGS

The foregoing and other features and advantages of the invention will become apparent to one skilled in the art upon consideration of the following description of the invention and the accompanying drawings in which:

FIG. 1 is a schematic illustration of a vehicle steering system constructed in accordance with the present invention to turn steerable vehicle wheels; and

FIG. 2 is a schematic illustration of a control system for the steering system of FIG. 1.

### DESCRIPTION

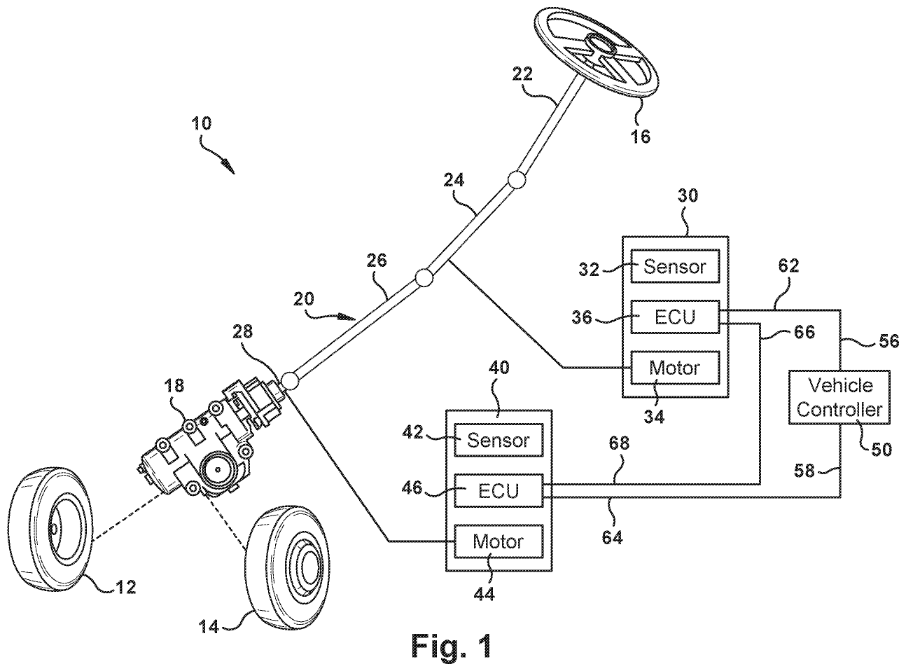

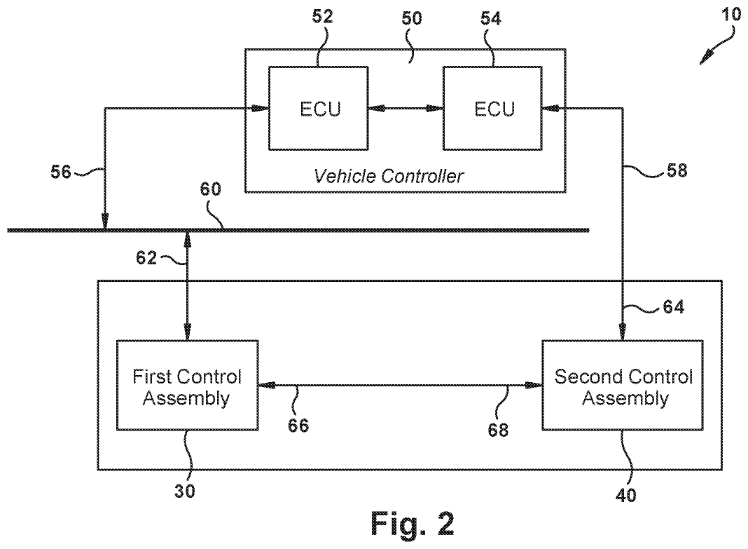

A steering system 10 to turn steerable vehicle wheels 12, 14 is schematically illustrated in FIGS. 1 and 2. The steering system 10 may be actuated by an operator/driver of the vehicle and/or actuated autonomously. The steering system 10 includes a handwheel or steering wheel 16 which may be rotated by an operator of the vehicle. The handwheel 16 is connected with a steering gear 18 by a steering column 20. The steering gear 18 may be any desired steering gear, such as a hydraulically powered integral steering gear or a rack and pinion type.

The steering column 20 may include a handwheel portion 22 which is connected with the handwheel 16. A first intermediate portion 24 of the steering column may be connected to the handwheel portion 22. A second intermediate portion 26 of the steering column 20 may be connected to the first intermediate portion 24 and an input shaft 28 of the steering gear 18. Universal joints may interconnect the handwheel portion 22, the first intermediate portion 24, the second intermediate portion 26 and the steering gear input shaft 28. Although the steering column 20 is shown as having a handwheel portion 22 and first and second intermediate portions 24, 26, it is contemplated that the steering column may have any desired construction.

Upon rotation of the handwheel 16, rotational force is transmitted through the steering column 20 to the steering gear 18. The rotational force effects operation of the steering gear 18. Upon operation of the steering gear 18, the steering gear effects turning movement of the steerable vehicle wheels 12, 14 in a known manner through a steering linkage.

The steering system 10 includes a first control assembly 30 which is operably connected with the steering column 20 at a first location that may be adjacent to the handwheel 16. The first control assembly 30 may be connected to the first intermediate portion 24 of the steering column 20. Although the first control assembly 30 is shown as being connected to the first intermediate portion 24, it is contemplated that the first control assembly may be connected to the steering column 20 at any desired location.

The first control assembly 30 includes at least a first sensor 32, a first reversible electric motor 34 and a first electronic control unit (ECU) 36. The first sensor 32 may sense torque applied to the steering column 20 and/or the angular position of the steering column. The first control assembly 30 may be integrated into a single unit through which the first intermediate portion 24 of the steering column 20 passes.

The first torque/position sensor 32 of the first assembly 30 is operable to sense applied torque and angular rotation of the steering wheel 16. The torque/position sensor 32 also generates signals indicative of the applied torque and angular rotation of the steering wheel 16. The torque/position sensor 32 may be any known sensor or group of sensors for sensing applied torque and angular rotation of the steering wheel 16 and for generating signals indicative of the sensed parameters.

The first electric motor 34 is operably connected to the first intermediate portion 24 of the steering column 20. A gear assembly may connect an output of the first electric motor 34 to the steering column 20 in a known manner. The first electric motor 34 applies a torque to the steering column 20 when actuated.

The first electronic control unit 36 is operatively coupled to the first torque/position sensor 32 and to the first electric motor 34. The first electronic control unit 36 may receive signals indicative of the applied torque and angular rotation of the steering wheel 16 from the torque/position sensor 32. The first ECU 36 may also receive signals indicative of vehicle speed, lateral acceleration, and/or other operating conditions associated with the vehicle. In response to the signals from the torque/position sensor 32, the first electronic control unit 36 may actuate the first electric motor 34 to apply a torque to the steering column 20. The first motor 34 may be operated to assist in rotating the first intermediate portion 24 and the handwheel 16. The first motor 34 may also be operated to resist rotation of the intermediate portion 24 and the handwheel 16 to provide “feel” to the operator rotating the handwheel. The first ECU 36 may effect operation of the first motor 34 to either assist or resist rotation of the steering column 20 as a function of vehicle operating conditions when the vehicle is being steered by an operator of the vehicle. Therefore, the first control assembly 30 may apply a desired rotational force to the first intermediate portion 24 of the steering column 20 to provide a desired output torque through the steering column.

A second control assembly 40 may be operably connected with the steering column 20 at a location adjacent to the steering gear 18. The second control assembly 40 may be connected to the input shaft 28 of the steering gear 18. Although the second control assembly 40 is shown as being connected to the input shaft 28, it is contemplated that the second control assembly may be connected to the steering column 20 at any desired location.

The second control assembly 40 may be substantially similar to the first control assembly 30 and includes at least a second sensor 42, a second reversible electric motor 44 and a second electronic control unit 46. The second sensor 42 may sense torque applied to the steering column 20 and/or the angular position of the steering column. The second control assembly 40 may be integrated into a single unit through which the input shaft 28 of the steering gear 18 passes.

The second torque/position sensor 42 of the second control assembly 40 is operable to sense applied torque and angular rotation of the input shaft 28. The second torque/position sensor 42 also generates signals indicative of the applied torque and angular rotation of the input shaft 28. The torque/position sensor 42 may be any known sensor or group of sensors for sensing applied torque and angular rotation of the input shaft 28 and for generating signals indicative of the sensed parameters.

The second electric motor 44 is operably connected to the input shaft 28 of the steering gear 18. A gear assembly may connect an output of the second electric motor 44 to the steering column in a known manner. The second electric motor 44 applies a torque to the steering column 20 when actuated.

The second electronic control unit 46 is operatively coupled to the second torque/position sensor 42 and to the second electric motor 44. The second electronic control unit 46 may receive signals indicative of the applied torque and angular rotation of the input shaft 28 from the second torque/position sensor 42. The second ECU 46 may also receive signals indicative of vehicle speed, lateral acceleration, and/or other operating conditions associated with the vehicle. In response to the signals from the second torque/position sensor 42, the second electronic control unit 46 may actuate the second electric motor 44 to apply a torque to the steering column 20 and the steering gear 18. The second motor 44 may be operated to assist in rotating the input shaft 28. The second motor 44 may also be operated to resist rotation of the input shaft 28. The second ECU 46 may effect operation of the second motor 44 to either assist or resist steering column rotation as a function of vehicle operating conditions when the vehicle is being steered by an operator of the vehicle. Therefore, the second control assembly 40 may apply a desired rotational force to the input shaft 28 of the steering gear 18 and/or to the second intermediate portion 26 of the steering column 20 to provide a desired output torque through the steering column.

A main vehicle controller 50 (FIG. 2) may communicate with the first and second control assemblies 30, 40 over communication channels, such as a Controller Area Network (CAN) or any other desired communication network. The vehicle controller 50 may have first and second ECUs 52, 54 that communicate with each other. The first and second ECUs 52, 54 may communicate with the first and second control assemblies 30, 40 via first and second communication channels 56, 58 of the vehicle controller and a vehicle communication bus 60. The first control assembly 30 may communicate with the vehicle communication bus 60 over a first communication channel 62 of the first control assembly. The second control assembly 40 may communicate directly with the vehicle controller 50 over a first communication channel 64 of the second control assembly. The first and second control assemblies 30, 40 may communicate directly with each other over second communication channels 66, 68 of the first and second control assemblies. The second communication channels 66, 68 may only communicate with each other. Therefore, the first and second control assemblies 30, 40 communicate with each other over dedicated communication channels of the first and second control assemblies.

The vehicle controller 50 may send signals to the ECUs 36, 46 of the first and second control assemblies 30, 40 to operate the vehicle autonomously. The vehicle controller 50 actuates at least one of the first and second control assemblies 30, 40 to turn the steering column 20 and the steerable vehicle wheels 12, 14 to steer the vehicle autonomously. It is contemplated that the vehicle controller 50 may actuate both of the first and second control assemblies simultaneously to turn the steerable vehicle wheels 12, 14.

The vehicle controller 50 may send the same position commands to the first and second control assemblies 30, 40 to create a redundant system. The first and second control assemblies 30, 40 may communicate with each other to determine which control assembly will steer the vehicle autonomously. The other control assembly will act as a backup or redundant control assembly and steer the vehicle autonomously if the one control assembly fails to steer the vehicle. For example, the first and second ECUs 36, 46 of the first and second control assemblies 30, 40 may communicate with each other and determine that the second control assembly 40 will steer the vehicle autonomously. The second ECU 46 of the second control assembly 40 receives the position signal or command from the vehicle controller 50 to autonomously steer the vehicle. In response to the position signal from the vehicle controller 50, the second ECU 46 actuates the second electric motor 44 to apply a torque to the steering column 20 and actuate the steering gear 18 to turn the steerable vehicle wheels 12, 14. The first ECU 36 of the first control assembly 30 communicates with the second ECU 46 of the second control assembly to determine if the first motor 34 needs to apply a torque to the steering column 20. The first ECU 36 of the first control assembly 30 does not actuate the first motor 34 if it is determined that the first motor does not need to apply a torque to the steering column 20. If it is determined that the first motor needs to apply a torque to the steering column 20, the first ECU actuates the first motor 34 to apply a torque to the steering column 20 in response to the position signal or command from the vehicle controller 50. Therefore, the first control assembly 30 acts as a backup for the second control assembly 40. The first control assembly 30 may autonomously turn the steering column 20 and the steerable vehicle wheels 12, 14 in response to the signals received from the vehicle controller 50 if the second control assembly 40 malfunctions.

If communication from the main controller 50 to the second control assembly 40 fails, the signals from the main controller may be transmitted through the first ECU 36 of the first control assembly 30 to the second control assembly. Thus, the second control assembly 40 may continue to apply torque to the steering column 20 and actuate the steering gear 18 to turn the steerable vehicle wheels 12, 14.

It is also possible that the first and second control assemblies 30, 40 communicate with each other and determine that the first control assembly 30 will steer the vehicle autonomously. The first ECU 36 of the first control assembly 30 receives a position signal or command from the vehicle controller 50 to autonomously steer the vehicle. In response to the position signal from the vehicle controller 50, the first ECU 36 actuates the first electric motor 34 to apply a torque to the steering column 20 to actuate the steering gear 18 and turn the steerable vehicle wheels 12, 14. The second ECU 46 of the second control assembly 40 communicates with the first ECU 36 of the first control assembly to determine if the second motor 44 needs to apply a torque to the steering column 20. The second ECU 46 of the second control assembly 40 does not actuate the second motor 44 if it is determined that the second motor does not need to apply a torque to the steering column 20. If it is determined that the second motor needs to apply a torque to the steering column 20, the second ECU actuates the second motor 44 to apply a torque to the steering column 20. Therefore, the second control assembly 40 acts as a backup for the first control assembly 30. The second control assembly 40 may autonomously turn the steering column 20 and the steerable vehicle wheels 12, 14 in response to the signals received from the vehicle controller 50 if the first control assembly 30 malfunctions.

If communication from the main controller 50 to the first control assembly 30 fails, the signals from the main controller may be transmitted through the second ECU 46 of the second control assembly 40 to the first control assembly. Thus, the first control assembly 30 may continue to apply torque to the steering column 20 and actuate the steering gear 18 to turn the steerable vehicle wheels 12, 14.

Each of the first and second control assemblies 30, 40 will know if it needs to act as an individual unit or in combination with the other control assembly. If one of the control assemblies 30, 40 is the only control assembly operating to steer the vehicle autonomously, then the one control assembly only accepts input commands that are related to operating the control assembly to steer the vehicle without assistance from the other control assembly. The other one of the control assemblies only accepts commands that are related to operating the other control assembly as a redundant or backup control assembly. Therefore, the control assemblies 30, 40 act as redundant systems for controlling steering of the vehicle autonomously. Also, at least one of the first and second control assemblies may provide steering assist and/or steering feel when an operator of the vehicle turns the handwheel 16,

The first and second ECUs 36, 46 of the first and second control assemblies 30, 40 may communicate with each other and share information to determine if the one of the first and second control assemblies is working correctly in response to the signals from the vehicle controller. If the one of the first and second control assemblies 30, 40 is not operating correctly, the other of the first and second control assemblies may turn the steering column 20 and/or actuate the steering gear 18 to turn the steerable vehicle wheels 12, 14 to operate the vehicle autonomously. It is also contemplated that the first and second control assemblies 30, 40 may work together to turn the steerable wheels 12, 14 if both are working properly.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A vehicle steering system for use in turning steerable vehicle wheels, the steering system comprising:
a steering column;
a steering gear operably connected with the steering column, the steering gear turning the steerable vehicle wheels upon rotation of the steering column;
a first control assembly connected to the steering column, the first control assembly having a first motor operably connected to the steering column for applying a torque to the steering column;
a second control assembly connected to the steering column, the second control assembly having a second motor operably connected to the steering column for applying a torque to the steering column, the second control assembly directly communicating with the first control assembly; and
a vehicle controller configured to communicate with the first and second control assemblies to autonomously steer the vehicle.

2. A vehicle steering system as set forth in claim 1 wherein the vehicle controller communicates with the first control assembly via a first communication channel of the vehicle controller.

3. A vehicle steering system as set forth in claim 2 wherein the vehicle controller communicates with the second control assembly via a second communication channel of the vehicle controller, the second communication channel of the vehicle controller being different than the first communication channel of the vehicle controller.

4. A vehicle steering system as set forth in claim 2 wherein the first control assembly communicates with a vehicle communication bus over a first communication channel of the first control assembly.

5. A vehicle steering system as set forth in claim 2 wherein the second control assembly communicates directly with the vehicle controller over a first communication channel of the second control assembly.

6. A vehicle steering system as set forth in claim 1 wherein the first and second control assemblies communicate directly with each other over dedicated communication channels of the first and second control assemblies.

7. A vehicle steering system as set forth in claim 1 wherein the first and second control assemblies receive a signal from the vehicle controller to autonomously steer the vehicle, one of the first and second motors applying a torque to the steering column to actuate the steering gear and turn the steerable vehicle wheels in response to the signal from the vehicle controller.

8. A vehicle steering system as set forth in claim 7 wherein the first and second control assemblies communicate with each other and determine which control assembly steers the vehicle autonomously.

9. A vehicle steering system as set forth in claim 1 wherein the first control assembly receives a signal from the vehicle controller to autonomously steer the vehicle, the first motor applies a torque to the steering column to actuate the steering gear and turn the steerable vehicle wheels in response to the signal from the vehicle controller.

10, A vehicle steering system as set forth in claim 9 wherein the second control assembly communicates with the first control assembly to determine if the second motor needs to apply a torque to the steering column.

11. A vehicle steering system as set forth in claim 10 wherein the second motor of the second control assembly applies a torque to the steering column.

12. A vehicle steering system as set forth in claim 1 wherein the signal from the main controller is transmitted through one of the first and second control assemblies to another of the first and second control assemblies, the other of the first and second control assemblies applying torque to the steering column and actuating the steering gear to turn the steerable vehicle wheels in response to the signal from the main controller.
